(19) United States
(12) Patent Application Publication
(10) Pub. No.: US 2007/0218089 A1
(43) Pub. Date: Sep. 20, 2007

(54) Aqueous Polymer Dispersion Containing Effect Materials, Method for Production and Use Thereof

(75) Inventors: Rainer Dyllick-Brenzinger, Speyer (DE); Alban Glaser, Mannheim (DE); Arno Bohm, Mannheim (DE)

Correspondence Address: OBLON, SPIVAK, MCCLELLAND, MAIER & NEUSTADT, P.C., 1940 DUKE STREET, ALEXANDRIA, VA, 22314, US

(73) Assignee: BASF Aktiengesellschaft, Ludwigshafen (DE)

(21) Appl. No.: 10/592,472

(22) PCT Filed: Mar. 9, 2005
(86) PCT No.: PCT/EP05/02484

§ 371 Date: Sep. 11, 2006

(30) Foreign Application Priority Data
Mar. 12, 2004 (DE) 10 2004 012 576.7

(51) Int. Cl. C08F 2/22; C08F 2/44; C08K 5/00; C08L 33/12

(52) U.S. Cl. 424/401; 428/407; 524/362; 524/804

(57) ABSTRACT

Aqueous polymer dispersions comprising effect substance and having an average particle diameter of the dispersed particles of <500 nm, where the polymer particles comprise a polymer matrix constructed from at least one ethylenically unsaturated monomer as core, on the surface of which is arranged at least partially an effect substance which is soluble in the monomers which form the polymer matrix of the particles, methods for producing such polymer dispersions by miniemulsion polymerization of ethylenically unsaturated monomers, wherein a miniemulsion with an average particle size of the emulsified particles of <500 nm is prepared by emulsifying ethylenically unsaturated monomers in water in the presence of at least one effect substance and a surface-active agent, and it is polymerized in such a way in the presence of at least one free-radical polymerization initiator that initially only at most 50% of the monomers which are situated in the polymerization zone polymerize and where the effect substances migrate to the surface of the emulsified particles, and the polymerization is complete only after extensive or complete accumulation of the effect substances on the surface of the resulting polymer particles, and use of the dispersions or the powders obtainable therefrom by evaporating off water for stabilizing polymers against the effect of UV radiation, oxygen and heat, in cosmetic and pharmaceutical formulations, in paint coats, during the production of paper, leather or textiles and in formulations for animal nutrition.

The invention relates to aqueous polymer dispersions comprising effect substances, to a method for producing these aqueous polymer dispersions by miniemulsion polymerization of ethylenically unsaturated monomers in the presence of effect substances and to the use of polymers comprising effect substances for stabilizing polymers against the effect of UV radiation, oxygen and heat, in cosmetic and pharmaceutical formulations, in surface coating layers, during the manufacture of paper, leather and textiles and in formulations for animal nutrition.

JP-A-7-292009 discloses aqueous polymer dispersions which comprise functional substances such as, in particular, UV absorbers or epoxy resins. They are prepared by dissolving the functional substances in an unsaturated monomer, emulsifying this solution in water in the presence of a surface-active agent to give a monomer emulsion with average particle sizes between 5 and 500 nm and polymerizing the miniemulsion in the presence of a free-radical initiator. The aqueous dispersions which comprise the functional substances such as UV absorbers, epoxy resins, polymers based on acrylic, phenol resins, unsaturated polyesters, substances based on phenol, and petroleum resins are used as binders and as additive for protective coating films.

WO-A-99/40123 discloses a method of producing aqueous polymer dispersions whose dispersed polymer particles comprise an organic dye in homogeneous, i.e. molecularly disperse, distribution. Such aqueous dispersions are prepared by miniemulsion polymerization by polymerizing ethylenically unsaturated monomers which comprise a dissolved organic dye in the form of an oil-in-water emulsion in the presence of polymerization initiators which form free radicals, where the disperse phase of the emulsion is essentially formed from dye-containing monomer droplets with a diameter of <500 nm. One advantageous embodiment of the invention uses monomer mixtures which comprise crosslinking monomers in the polymerization. The polymer dispersions are sedimentation-stable. The dispersed particles have an average particle diameter of from 100 to 400 nm. They can be obtained from the aqueous dispersions using conventional drying methods. The dye-containing polymer dispersions are used, for example, for pigmenting high molecular weight organic and inorganic materials, for pigmenting printing inks and inks for ink-jet printing.

EP-A-1 092 416 discloses the use of finely divided aqueous polymer dispersions comprising dyes, optical brighteners or UV absorbers, or of a pulverulent polymer obtainable therefrom, whose polymer matrix comprises dyes, optical brighteners or UV absorbers in homogeneous distribution as color-imparting constituent in cosmetic compositions. The dispersions are preferably prepared by the method known from WO-A-99/40123 by miniemulsion polymerization of ethylenically unsaturated monomers which comprise a dye, optical brightener or UV absorber in dissolved form.

Further colorant-containing polymer dispersions whose colorant-containing polymer particles have an average particle diameter below 1000 nm are known from EP-A-1 191 041. Besides organic dyes, suitable colorants are also UV absorbers and optical brighteners. They are prepared by dissolving a colorant in at least one ethylenically unsaturated monomer, emulsifying this solution in water to form a conventional macroemulsion, homogenizing the macroemulsion to form a miniemulsion with an average droplet size of less than 1000 nm and polymerizing the miniemulsion in the presence of a polymerization initiator which forms free radicals, 0.1 to 20% by weight of at least one nonionic surface-active compound and 1 to 50% by weight, in each case based on the monomers used, of at least one amphiphilic polymer. The polymer particles comprise 0.5 to 50% by weight of at least one organic dye, optical brightener or UV absorber in homogeneous distribution, which can be understood as meaning that the organic colorants are dissolved in the polymer matrix in monomolecular form or are present in the form of bi- or polymolecular aggregates.

WO-A-01/10936 discloses particles with a core/shell structure in which the core comprises a polymer with a glass transition temperature T_{g} of less than 40° C. and a UV absorber and the shell preferably consists of a polymer of methyl acrylate, ethyl acrylate, ethyl methacrylate and/or methyl methacrylate. The polymer which forms the core of the particle can, if appropriate, be crosslinked. The polymer particles are prepared by emulsion polymerization. The polymer particles comprising UV absorbers are used for producing UV-absorbing polymer compositions.

The earlier DE application 102 48 879.7 discloses aqueous polymer dispersions comprising alkyldiketenes which are obtainable by miniemulsion polymerization of hydrophobic monoethylenically unsaturated monomers in the presence of alkyldiketenes. These dispersions are used as sizing agents for paper, as hydrophobicizing agents for leather, natural and/or synthetic fibers and textiles.

The earlier DE application 102 54 548.0 discloses the use of finely divided polymer powders comprising at least one UV absorber for stabilizing polymers against the effect of UV radiation. The polymer particles of the polymer powders have a particle size of 500 nm and below. They are preferably prepared by miniemulsion polymerization by methods which are known from the abovementioned specifications WO-A-99/40123, EP-A-1 092 415 and EP-A-1 191 041. The polymer particles comprise 0.5 to 50% by weight of at least one UV absorber which is present therein either in homogeneous distribution in molecular or nanocrystalline form, or else is surrounded completely or else only partially by the polymer matrix.

U.S. Pat. No. 6,309,787 discloses a method for encapsulating dyes by miniemulsion polymerization where the miniemulsion is prepared in the presence of a surface-active agent, a cosurfactant and a nonionic surface-active agent. After the polymerization, dispersed particles are obtained which are constructed from a dye core and a polymer shell.

DE-A-196 28 143 discloses a method of producing an aqueous polymer dispersion. The monomers are polymerized by a type of free-radical aqueous miniemulsion polymerization during which at least some of the aqueous monomer miniemulsion is continuously fed to the polymerization zone as the polymerization continues.

The object of the present invention was to provide aqueous polymer dispersions comprising further effect substances.

The object is achieved according to the invention with aqueous polymer dispersions comprising effect substances and having an average particle diameter of the dispersed particles of <500 nm, where the polymer particles comprise a polymer matrix constructed from at least one ethylenically unsaturated monomer as core, on the surface of which is arranged at least partially an effect substance which is soluble in the monomers which form the polymer matrix of the particles. The effect substances are preferably arranged as a shell around the core of the polymer particles.

The invention further provides a method of producing finely divided aqueous polymer dispersions comprising effect substances and having an average particle diameter of the dispersed polymer particles of <500 nm by miniemulsion polymerization of ethylenically unsaturated monomers if a miniemulsion with an average particle size of the emulsified particles of <500 nm is prepared by emulsifying ethylenically unsaturated monomers in water in the presence of at least one effect substance and a surface-active agent, and it is polymerized in such a way in the presence of at least one free-radical polymerization initiator that initially only at most 50% of the monomers which are situated in the polymerization zone polymerize and where the effect substances migrate to the surface of the emulsified particles, and the polymerization is complete only after extensive or complete accumulation of the effect substances on the surface of the resulting polymer particles.

For the purposes of the invention, effect substances are understood as meaning products which are chosen, for example, from the group of UV absorbers, organic dyes, optical brighteners, stabilizers and auxiliaries for organic polymers, IR dyes, flame retardants, alkenylsuccinic anhydrides, pharmaceutical active ingredients and biocides. Suitable effect substances are soluble in the ethylenically unsaturated monomers which form the core of the polymer particles of the aqueous dispersion. The solubility of the effect substances in the monomers is, for example, at least 1 g/l, preferably at least 10 g/l, at a temperature of 20° C. and a pressure of 1 bar. The amount of effect substances which is arranged on the surface of the dispersed polymer particles is, for example, 0.5 to 50% by weight, preferably 2 to 20% by weight, based on the polymer matrix.

The miniemulsion polymerization of ethylenically unsaturated monomers in the presence of oil-soluble dyes is known, for example, from the WO-A-99/40123 cited in the prior art. In respect of the details of this polymerization method, reference is made in particular to page 3, line 30 to page 38, line 6 and to page 69, line 11 to page 84, line 43 of WO-A-99/40123. This section of the WO application is thus incorporated into the disclosure content of the present invention by reference. The ethylenically unsaturated monomers, nonpolymerizable organic dyes, auxiliaries and process measures described therein for producing the miniemulsion are applied in the same way for the method according to the invention. The essential difference from the known process is the special way in which the polymerization is carried out according to the invention. Apart from an oil-soluble, nonpolymerizable dye, in the method according to the invention, other effect substances can also be used which are likewise soluble in ethylenically unsaturated monomers. As effect substances, particular preference is given to using UV absorbers which are likewise oil-soluble and are preferably dissolved in the monoethylenically unsaturated monomers from which the core of the polymers is essentially formed. UV absorbers are commercial products. They are sold, for example, under the trade name Uvinul® by BASF Aktiengesellschaft, Ludwigshafen.

As is known, UV absorbers are understood as meaning compounds which absorb UV rays and deactivate the absorbed radiation in a nonradiative manner. UV absorbers absorb light with a wavelength of <400 nm and convert it into thermal radiation. Such compounds are used, for example, in sunscreen compositions and for stabilizing organic polymers. Examples of UV absorbers are derivatives of p-aminobenzoic acid, in particular esters thereof, e.g. ethyl 4-aminobenzoate and ethoxylated ethyl 4-amino-benzoate, salicylates, substituted cinnamic esters (cinnamates) such as octyl p-methoxycinnamate and 4-isopentyl-4-methoxycinnamate, 2-phenylbenzimidazole-5-sulfonic acid and its salts. One UV absorber which is particularly preferably used is 4-n-octyloxy-2-hydroxybenzophenone. Other examples of UV absorbers are:

substituted acrylates, such as, for example, ethyl or isooctyl α-cyano-β,β-diphenyl-acrylate (primarily 2-ethylhexyl α-cyano-β,β-diphenylacrylate), methyl α-methoxy-carbonyl-β-phenylacrylate, methyl α-methoxycarbonyl-β-(p-methoxyphenyl)acrylate, methyl or butyl α-cyano-β-methyl-β-(p-methoxyphenyl)acrylate, N-(β-methoxycarbonyl-β-cyanovinyl)-2-methylindoline, octyl p-methoxycinnamate, isopentyl 4-methoxy-cinnamate, urocaninic acid and salts and esters thereof;

2-hydroxybenzophenone derivatives, such as, for example, 4-hydroxy-, 4-methoxy-, 4-octyloxy-, 4-decyloxy-, 4-dodecyloxy-, 4-benzyloxy-, 4,2′,4′- trihydroxy-, 2′-hydroxy-4,4′-dimethoxy-2-hydroxybenzophenone, and 4-methoxy-2-hydroxybenzophenone sulfonic acid sodium salt;

esters of 4,4-diphenylbutadiene-1,1-dicarboxylic acid, such as, for example, the bis(2-ethylhexyl) ester;

2-phenylbenzimidazole-4-sulfonic acid and 2-phenylbenzimidazole-5-sulfonic acid and salts thereof;

derivatives of benzoxazoles;

derivatives of benzotriazoles and 2-(2′-hydroxyphenyl)benzotriazoles, such as, for example, 2-(2H-benzotriazol-2-yl)-4-methyl-6-(2-methyl-3-(( 1,1,3,3-tetramethyl-1-(trimethylsilyloxy)disiloxanyl)propyl)phenol, 2-(2′-hydroxy-5′-methylphenyl)benzotriazole, 2-(3′,5′-di-tert-butyl-2′-hydroxyphenyl)benzotriazole, 2-(5′-tert-butyl-2′-hydroxyphenyl)benzotriazole, 2-[2′-hydroxy-5′-(1,1,3,3-tetramethylbutyl)phenyl]benzotriazole, 2-(3′,5′-di-tert-butyl-2′-hydroxyphenyl)-5-chlorobenzotriazole, 2-(3′-tert-butyl-2′-hydroxy-5′-methylphenyl)-5-chlorobenzotriazole, 2-(3′-sec-butyl-5′-tert-butyl-2′-hydroxyphenyl)benzotriazole, 2-(2′-hydroxy-4′-octyloxyphenyl)-benzotriazole, 2-(3′,5′-di-tert-amyl-2′-hydroxyphenyl)benzotriazole, 2-[3′,5′-bis(α,α-dimethylbenzyl)-2′-hydroxyphenyl]benzotriazole, 2-[3′-tert-butyl-2′-hydroxy-5′-(2-octyloxycarbonylethyl)phenyl]-5-chlorobenzotriazole, 2-[3′-tert-butyl-5′-(2-(2-ethylhexyloxy)carbonylethyl)-2′-hydroxyphenyl]-5-chlorobenzotriazole, 2-[3′-tert-butyl-2′-hydroxy-5′-(2-methoxycarbonylethyl)-phenyl]-5-chlorobenzotriazole, 2-[3′-tert-butyl-2′-hydroxy-5′-(2-methoxycarbonylethyl)-phenyl]benzotriazole, 2-[3′-tert-butyl-2′-hydroxy-5′-(2-octyloxycarbonylethyl)phenyl]-benzotriazole, 2-[3′-tert-butyl-5′-(2-(2-ethylhexyloxy)carbonylethyl)-2′-hydroxyphenyl]-benzotriazole, 2-(3′-dodecyl-2′-hydroxy-5′-methylphenyl)benzotriazole, 2-[3′-tert-butyl-2′-hydroxy-5′-(2-isooctyloxycarbonylethyl)phenyl]benzotriazole, 2,2′-methylene-bis[4-(1,1,3,3-tetramethylbutyl)-6-benzotriazol-2-ylphenol], the completely esterified product of 2-[3′-tert-butyl-5′-(2-methoxycarbonylethyl)-2′-hydroxyphenyl]-2H-benzotriazole with polyethylene glycol 300, [R—CH₂CH₂—COO(CH₂)₃—]₂ where R is 3′-tert-butyl4-hydroxy-5′-2H-benzotriazol-2-ylphenyl, 2-[2′-hydroxy-3′-(α,α-dimethylbenzyl)-5′-( 1,1,3,3-tetramethylbutyl)phenyl]benzotriazole, 2-[2′-hydroxy-3′-(1,1,3,3-tetramethylbutyl)-5′-(α,α-dimethylbenzyl)phenyl]benzotriazole;

benzylidenecamphor and its derivatives, as are specified, for example, in DE-A 3 836 630, e.g. 3-benzylidenecamphor, 3-(4′-methylbenzylidene)d-1-camphor;

α-(2-oxoborn-3-ylidene)toluene-4-sulfonic acid and its salts, N,N,N-trimethyl-4-(2-oxoborn-3-ylidenemethyl)anilinium methosulfate;

dibenzoylmethanes, such as, for example, 4-tert-butyl-4′-methoxydibenzoylmethane;

2,4,6-triaryltriazine compounds, such as 2,4,6-tris-{N-[4-(2-ethylhex-1-yl)oxycarbonylphenyl]amino}-1,3,5-triazine, bis(2′-ethylhexyl) 4,4′-((6-(((tert-butyl)aminocarbonyl)phenylamino)-1,3,5-triazine-2,4-diyl)imino)bis(benzoate); and

2-(2-hydroxyphenyl)-1,3,5-triazines, such as, for example, 2,4,6-tris(2-hydroxy-4-octyloxyphenyl)-1,3,5-triazine, 2-(2-hydroxy-4-octyloxyphenyl)-4,6-bis(2,4-dimethylphenyl)-1,3,5-triazine, 2-(2,4-dihydroxyphenyl)-4,6-bis(2,4-dimethylphenyl)-1,3,5-triazine, 2,4-bis(2-hydroxy-4-propyloxyphenyl)-6-(2,4-dimethylphenyl)-1,3,5-triazine, 2-(2-hydroxy-4-octyloxyphenyl)-4,6-bis(4-methylphenyl)-1,3,5-triazine, 2-(2-hydroxy-4-dodecyloxyphenyl)-4,6-bis(2,4-dimethylphenyl)-1,3,5-triazine, 2-[2-hydroxy-4-(2-hydroxy-3-butyloxypropyloxy)phenyl]-4,6-bis(2,4-dimethylphenyl)-1,3,5-triazine, 2-[2-hydroxy-4-(2-hydroxy-3-octyloxypropyloxy)phenyl]-4,6-bis(2,4-di-methylphenyl)-1,3,5-triazine, 2-(2-hydroxy-4-tridecyloxyphenyl)-4,6-bis(2,4-dimethylphenyl)-1,3,5-triazine, 2-[4-(dodecyloxy/tridecyloxy-2-hydroxypropoxy)-2-hydroxyphenyl]-4,6-bis(2,4-dimethylphenyl)-1,3,5-triazine, 2-[2-hydroxy-4(2-hydroxy-3-dodecyloxypropoxy)phenyl]-4,6-bis-(2,4-dimethylphenyl)-1,3,5-triazine, 2-(2-hydroxy-4-hexyloxyphenyl)-4,6-diphenyl-1,3,5-triazine, 2-(2-hydroxy-4-methoxyphenyl)-4,6-diphenyl-1,3,5-triazine, 2,4,6-tris[2-hydroxy-4-(3-butoxy-2-hydroxypropoxy)phenyl]-1,3,5-triazine, 2-(2-hydroxyphenyl)-4-(4-methoxyphenyl)-6-phenyl-1,3,5-triazine, 2-{2-hydroxy-4-[3-(2-ethylhexyl-1-oxy)-2-hydroxypropyloxy]phenyl}-4,6-bis(2,4-dimethylphenyl)-1,3,5-triazine.

Further suitable UV absorbers can be found in the publication Cosmetic Legislation, Vol. 1, Cosmetic Products, European Commission 1999, pp. 64-66. to which reference is hereby made.

Suitable UV absorbers are also described in lines 14 to 30 on page 6 of EP-A-1 191 041.

Other effect substances are organic dyes and optical brighteners which in each case dissolve in ethylenically unsaturated monomers and which are themselves not polymerizable. Such dyes and optical brighteners are described in detail in WO-A-99/40123, page 10, line 14 to page 25, line 25, cited in the prior art and to which reference is again expressly made. While organic dyes have an absorption maximum in the wavelength range from 400 to 850 nm, optical brighteners have one or more absorption maxima in the range from 250 to 400 nm. As is known, upon irradiation with UV light, optical brighteners emit fluorescent radiation in the visible region. Examples of optical brighteners are compounds from the classes of bisstyrylbenzenes, stilbenes, benzoxazoles, coumarins, pyrenes and naphthalenes. Commercially available optical brighteners are sold under the trade names Tinopal® (Ciba), Ultraphor® (BASF Aktiengesellschaft) and Blankophor® (Bayer). Optical brighteners are also described in Römpp, 10th edition, Volume 4, 3028-3029 (1998) and in Ullmanns Encyclopedia of Industrial Chemistry, Vol. 24, 363-386 (2003).

Suitable effect substances are also stabilizers for organic polymers. These are compounds which stabilize polymers against degradation upon exposure to oxygen, light or heat. Such stabilizers are also referred to as antioxidants or as UV stabilizers and photostabilizers, cf. Ullmanns Encyclopedia of Industrial Chemistry, Vol. 3, 629-650 (ISBN-3-527-30385-5) and EP-A-1 110 999, page 2, line 29 to page 38, line 29. Using such stabilizers it is possible to stabilize virtually all organic polymers, cf. EP-A-1 110 999, page 38, line 30 to page 41, line 35. This literature reference too is also incorporated into the disclosure content of the present invention by reference. The stabilizers described in the EP application belong to the class of compound of the pyrazolones, the organic phosphites or phosphonites, the sterically hindered phenols and the sterically hindered amines (stabilizers of the so-called HALS type, cf. Römpp, 10th edition, Volume 5, pages 4206-4207). Commercially available stabilizers and auxiliaries are sold under the names Tinuvin® and Cyasorb® by Ciba and Tenox® by Eastman Kodak. Stabilizers and auxiliaries are described, for example, in Plastics Additives Handbook, 5th edition, Hanser, ISBN 1-56990-295-X. The stabilizers and auxiliaries are soluble in ethylenically unsaturated monomers, with at least 1 g/l, preferably at least 10 g/l dissolving at a temperature of 20° C. and a pressure of 1 bar.

Further suitable effect substances are IR dyes which are sold, for example, by BASF Aktiengesellschaft as Lumogen® IR, and flame retardants, which are described, for example, in Römpp, 10th edition, pages 1352 and 1353, and in Ullmanns Encyclopedia of Industrial Chemistry, Vol. 14, 53-71. Suitable flame retardants are soluble in ethylenically unsaturated monomers.

Effect substances should also be understood as meaning alkenylsuccinic anhydrides, which are known, for example, as bulk sizing agents for paper and are used industrially to a great extent. Examples of such sizing agents are the isomeric 4-, 5-, 6-, 7- and 8-hexadecenylsuccinic anhydrides, decenylsuccinic anhydride, octenylsuccinic anhydride, dodecenylsuccinic anhydride and n-hexadecenylsuccinic anhydride, cf. also C. E. Farley and R. B. Wasser, The Sizing of Paper, Second Edition, (3), Sizing With Alkenyl Succinic Anhydride, TAPPI PRESS, 1989, ISBN 0-89852-051-7.

Further effect substances which may be used are all pharmaceutical active ingredients which are soluble in ethylenically unsaturated monomers. An overview of pharmaceutical active ingredients is given, for example, in Römpp, 10th edition, Volume 4, page 3235 (ISBN-3-13-734910-9) and in Ullmanns Encyclopedia of Industrial Chemistry, Vol. 25, 549-579 (2003). In the present connection, pharmaceutical active ingredients should also be understood as meaning vitamins.

Vitamins are soluble in ethylenically unsaturated monomers. A summary of vitamins can be found, for example, in Römpp, 10th edition, Volume 6, page 4877-4887 (1999) and in Ullmanns Encyclopedia of Industrial Chemistry, Vol. 38, 109-294.

Further suitable effect substances are perfumes, cf. Ullmanns Encyclopedia of Industrial Chemistry, Vol. 14, 73-199, and biocides, cf. Ullmanns Encyclopedia of Industrial Chemistry, Vol. 5, 269-280.

The core of the dispersed particles is essentially built up from a polymer of

(a) at least one ethylenically unsaturated monomer A with a solubility in water of >0.01 g/l, if appropriate,

(b) at least one ethylenically unsaturated monomer B with a solubility in water of <0.01 g/l and, if appropriate,

(c) at least one ethylenically unsaturated monomer with at least two double bonds.

The solubility in water of the monomers refers in each case to the solubility of the monomers in water at a temperature of 25° C. and a pressure of 1 bar.

The dispersed polymer particles in most cases comprise

(a) 50 to 99.5% by weight of at least one monomer A,

(b) 0.5 to 50% by weight of at least one monomer B and

(c) 0 to 30% by weight of at least one monomer C

in copolymerized form.

Suitable monomers are described in detail in WO-A-99/40123, page 4, line 41 to page 10, line 12, to which reference is again made at this point. Monomers of groups (a) to (c) are to be specified merely by way of example, and specifically monomers of group (a) are styrene, α-methylstyrene, vinyl acetate, vinyl propionate, dimethyl maleate, diethyl maleate, esters of ethylenically unsaturated C₃- to C₅-carboxylic acids and monohydric alcohols having 1 to 6 carbon atoms and allyl acetate.

The monomers (a) also comprise those monomers A′ which have increased solubility in water, i.e. >60 g/l at 25° C. and 1 bar. The monomers A′ are used for modifying the polymers and are mostly involved in amounts of from 0.1 to 20% by weight, preferably from 0.5 to 10% by weight, in the construction of the polymer matrix. Examples of these monomers are acrylic acid, methacrylic acid, styrenesulfonic acid, 2-acrylamido-2-methylpropanesulfonic acid and vinylphosphonic acid, and cationic monomers, such as dimethylaminoethyl acrylate or 1-vinylimidazole, and N-vinylformamide N-vinyl-pyrrolidone. The basic monomers are used in the form of the free bases, as salt or in quaternized form during the polymerization. The monomers having acid groups can be used in the polymerization in the form of the free acids or in a form which is partially or completely neutralized with alkali metal bases or ammonium bases.

Suitable monomers of group (b) are, for example, 2- and 4-methylstyrene, p-tert-butylstyrene, esters of ethylenically unsaturated C₃- to C₅-carboxylic acids and alcohols with more than 12 carbon atoms in the molecule, vinyl laurate, vinyl stearate and macromonomers such as oligopropene acrylate.

Examples of monomers of group (c) are glycol diacrylate, trimethylolpropane triacrylate, pentaerythritol triacrylate, pentaerythritol tetraacrylate, butanediol diacrylate, allyl acrylate, divinylbenzene, divinylurea and methylenebisacrylamide.

Thus, for example, the polymer matrix of the dispersed polymer particles can be constructed from a polymer of

(a) methyl methacrylate, styrene, vinyl acetate, methyl acrylate, ethyl methacrylate, acrylic acid and/or methacrylic acid, if appropriate,

(b) lauryl acrylate, palmityl acrylate and/or stearyl acrylate and, if appropriate,

(c) butanediol diacrylate, divinylbenzene, pentaerythritol triacrylate and/or pentaerythritol tetraacrylate.

The polymer matrix of the particles dispersed in water preferably consists of a copolymer which is obtainable by polymerization of

(a) methyl methacrylate, ethyl methacrylate and/or acrylic acid,

(b) stearyl acrylate and/or palmityl acrylate and

(c) butanediol diacrylate, pentaerythritol tetraacrylate and/or pentaerythritol triacrylate.

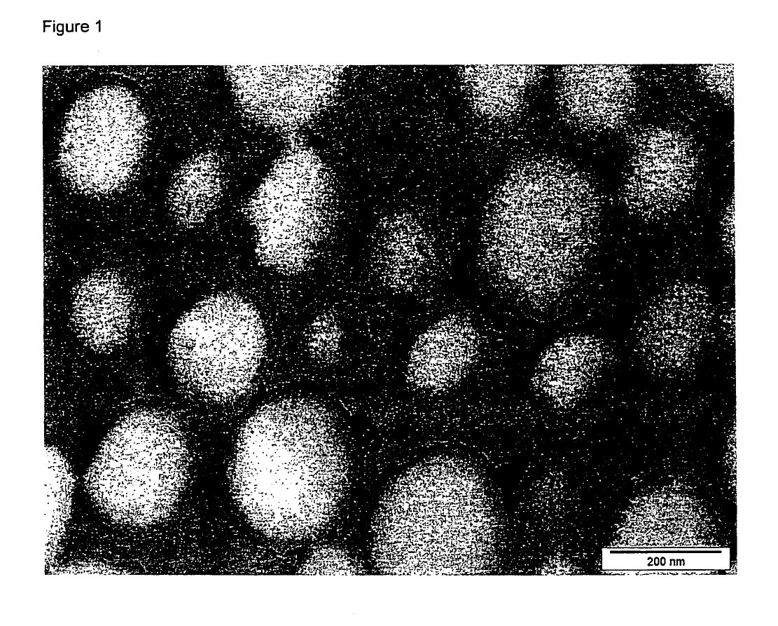

The aqueous polymer dispersions according to the invention comprise dispersed particles with an average particle diameter of <500 nm, preferably 50 to 400 nm. The polymer particles consist essentially of a polymer core on whose surface at least one effect substance is arranged. In the ideal case, the effect substance forms a shell around the polymer core. Such a construction of polymer particles can be seen from FIG. 1. This is an electron micrograph of a section of a powder sample which has been obtained from an aqueous polymer dispersion by distilling off the water. The effect substances are virtually incompatible with the polymer and/or insoluble in the polymer which forms the core of the dispersed particle. They can therefore be found on or at the surface of the polymer matrix as a nanoscale shell.

Particular preference is given to aqueous polymer dispersions whose dispersed polymer particles are constructed from a polymer of

(a) methyl methacrylate or methyl methacrylate and acrylic acid,

(b) if appropriate, stearyl acrylate and

(c) butanediol diacrylate, pentaerythritol tetraacrylate and/or pentaerythritol triacrylate

and are coated with a shell of a UV absorber, in particular 4-n-octyloxy-2-hydroxy-benzophenone.

The monomers are used in the polymerization, for example, in amounts such that the resulting polymers comprise

(a) 50 to 99.5% by weight, preferably 80 to 99% by weight, of at least one monomer A and

(b) 0.5 to 50% by weight, preferably 1 to 20% by weight, of at least one monomer B in copolymerized form.

The polymer matrix which forms the core of the dispersed particles preferably comprises a monomer (c) in an amount of from 0.1 to 30% by weight, in particular 0.5 to 20% by weight, in most cases 1 to 10% by weight, in copolymerized form.

The inventive aqueous polymer dispersions comprising effect substances and having an average particle diameter of the dispersed polymer particles of <500 nm are prepared by miniemulsion polymerization of ethylenically unsaturated monomers. The procedure here involves, for example, firstly dissolving at least one effect substance in at least one monomer. The effect substances are in most cases dissolved in monomolecular form, but can also be present in colloidally disperse dissolved form. The monomer solutions comprising effect substances are then emulsified in water in the presence of at least one surface-active agent. Instead of or in addition to a surface-active agent, microparticles or nanoparticles that are insoluble in water and/or the monomers can also be used as stabilizer for the emulsion (Pickering effect). Stabilizers of this type are, for example, nanoscale silicon dioxide, aluminum oxide and magnesium sulfate. This gives a miniemulsion with an average particle size of the emulsified droplets of <500 nm. The emulsification takes place by methods which are described in WO-A-99/40123, page 26, line 11 to page 32, line 4. For example, for the emulsification, use is made of high-pressure homogenizers of varying design, or a macroemulsion which comprises, as essential constituents, at least one effect substance, which is dissolved in at least one monomer, and water, is subjected to ultrasound. In most cases, the mixture emulsifies in the presence of a surface-active agent. However, it is also possible to add the effect substances to the miniemulsion. However, they are preferably, as described above, firstly dissolved in at least one monomer and emulsified in dissolved or colloidally disperse dissolved form in water.

The aqueous phase which is used for preparing the miniemulsion consists of water and comprises, if appropriate, a surface-active agent which stabilizes the finely divided monomer droplets formed upon emulsion of the organic phase in the aqueous phase. The surface-active agent is used, for example, in amounts of up to 15% by weight, e.g. from 0.05 to 15% by weight, preferably 0.05 to 5% by weight and in particular 0.1 to 2% by weight, based on the total dispersion. It is either in the aqueous phase, the organic phase or in both phases. It is preferably added to the aqueous phase prior to emulsification. It is in principle possible to use all surface-active agents. Surface-active agents preferably used are anionic compounds. Examples of suitable surface-active agents are sodium lauryl sulfate, sodium dodecyl sulfate, sodium hexadecyl sulfate, sodium dioctyl sulfosuccinate and/or addition products of from 15 to 50 mol of ethylene oxide onto 1 mol of a C₁₂- to C₂₂-alcohol.

In order to stabilize a miniemulsion, use is made for the preparation of these emulsions, if appropriate, of at least one nonpolymerizable hydrophobic compound, e.g. a hydrocarbon, an alcohol with 10 to 24 carbon atoms, hydrophobic polymers with molar masses Mw of <50 000, preferably <10 000, tetraalkylsilanes and/or mixtures of said compounds. Examples of such stabilizers are hexadecane decahydronaphthalene, olive oil, polystyrene with an average molar mass M_{w} of <50 000, preferably from 500 to 5000, siloxanes with a molar mass Mw of from 500 to 5000, poly-n-butyl acrylate such as Acronal® A 150 F, cetyl alcohol, stearyl alcohol, palmityl alcohol and/or biphenyl alcohol. The hydrophobic, nonpolymerizable compounds are used as desired. They have a solubility in water of <0.1 g/l at 25° C. and 1 bar. If they are used, they are used in amounts of, for example, from 1 to 20% by weight, mostly 1 to 10% by weight, and preferably 2 to 6% by weight, based on the monomers used for the polymerization.

In order to obtain stable aqueous polymer dispersions, the polymerization can, if appropriate, also additionally be carried out in the presence of protective colloids. They generally have average molar masses M_{w} of more than 500, preferably of more than 1000. Examples of protective colloids are polyvinyl alcohols, cellulose derivatives, such as carboxymethylcellulose, polyvinylpyrrolidone, polyethylene glycols, graft polymers of vinyl acetate and/or vinyl propionate onto polyethylene glycols, polyethylene glycols terminally capped at one or both ends with alkyl, carboxyl or amino groups, polydiallyl-dimethylammonium chlorides and/or polysaccharides, such as, in particular, water-soluble starches, starch derivatives and proteins. Such products are described, for example, in Römpp, Chemie Lexikon 9th edition, volume 5, page 3569 or in Houben-Weyl, Methoden der organischen Chemie [Methods of organic chemistry], 4th edition, volume 14/2 chapter IV Conversion of Cellulose and Starch by E. Husemann and R. Wemer, pages 862-915 and in Ullmanns Encyclopedia for Industrial Chemistry, 6th edition, volume 28, pages 533 ff under Polysaccharides.

All types of starch, for example, are suitable, e.g. both amylose and amylopectin, native starches, hydrophobically or hydrophilically modified starches, anionic starches, cationically modified starches, degraded starches, where the degradation of starch may be carried out, for example, oxidatively, thermally, hydrolytically or enzymatically and where either native or modified starches can be used for the degradation of starch. Further suitable protective colloids are dextrins and crosslinked water-soluble starches which are swellable in water.

As protective colloid, preference is given to using native, water-soluble starches which can be converted to a water-soluble form, for example using a starch degradation, and also anionically modified starches such as oxidized potato starch. Particular preference is given to anionically modified starches which have been subjected to molecular weight degradation. The molecular weight degradation is preferably carried out enzymatically. The average molar mass M_{w} of the degraded starches is, for example, 500 to 100 000, preferably 1000 to 30 000. The degraded starches have, for example, an intrinsic viscosity [η] of from 0.04 to 0.5 dl/g. Such starches are described, for example, in EP-B-0 257 412 and in EP-B-0 276 770. If protective colloids are used during the polymerization, the amounts used are, for example, 0.5 to 15% by weight, in particular 1 to 10% by weight, based on the monomers used in the polymerization. In order to modify the properties of the polymers, the polymerization can, if appropriate, be carried out in the presence of at least one polymerization regulator. Examples of polymerization regulators are organic compounds which comprise sulfur in bonded form, such as dodecyl mercaptan, thiodiglycol, ethylthioethanol, di-n-butyl sulfide, di-n-octyl sulfide, diphenyl sulfide, diisopropyl disulfide, 2-mercaptoethanol, 1,3-mercapto-propanol, 3-mercaptopropane-1,2-diol, 1,4-mercaptobutanol, thioglycolic acid, 3-mercaptopropionic acid, mercaptosuccinic acid, thioacetic acid and thiourea, aldehydes, such as formaldehyde, acetaldehyde and propionaldehyde, organic acids, such as formic acid, sodium formate or ammonium formate, alcohols, such as, in particular, isopropanol, and phosphorus compounds, such as sodium hypophosphite. If a regulator is used in the polymerization, then the amount used in each case is, for example, 0.01 to 5% by weight, preferably 0.1 to 1% by weight, based on the monomers used in the polymerization. Polymerization regulators and crosslinkers can be used together in the polymerization. The miniemulsion is polymerized in the presence of at least one free-radical polymerization initiator. Suitable polymerization initiators are all compounds which can trigger a polymerization. These are essentially peroxides, hydroperoxides, azo compounds and redox catalysts. Examples of initiators can be found in WO-A-99/40123, page 32, line 45 to page 34, line 9. The polymerization can also be triggered by the effect of high-energy radiation, such as UV radiation. The polymerization temperature is, for example, 0 to 120° C., it being carried out at temperatures above 100° C. under increased pressure in pressure-tight apparatuses. In most cases, the miniemulsion is polymerized in the temperature range from 0 to 95° C.

The polymerization is carried out according to invention such that initially only at most 50% of the monomers which are situated in the polymerization zone polymerize. The effect substances migrate to the surface of the emulsified particles. Presumably, there is incompatibility between the effect substances and the polymer core which forms, or the effect substances are not soluble in the corresponding polymer or the mixture of monomer, oligomers and polymers. The polymerizing system only has to be given sufficient time for the effect substances to be able to separate from the polymer which forms. The polymerization is only completed following extensive or complete accumulation of the effect substances on the surface of the resulting polymer particles. By taking samples during the polymerization it is possible to monitor the separation of effect substance and polymer which forms. The effect substances remain essentially at the surface of the polymer particle, but may also, if appropriate, partially enter the aqueous phase, form domains within the polymer particles or accumulate in some other way within the polymer, depending on the polymerization conditions.

For example, preference is given to firstly preparing a miniemulsion comprising at least one effect substance of

(a) at least one ethylenically unsaturated monomer A with a solubility in water of >0.01 g/l (at 25° C. and 1 bar), if appropriate,

(b) at least one ethylenically unsaturated monomer B with a solubility in water of <0.01 g/l (at 25° C. and 1 bar) and, if appropriate,

(c) at least one ethylenically unsaturated monomer C with at least two double bonds,

at least one emulsifier and a hydrophobic organic compound with a solubility in water of <0.1 g/l (at 25° C. and 1 bar), where the effect substances can also be added to the miniemulsion during the emulsification operation or after it, then polymerizing the monomers of the miniemulsion to a conversion of at most 50%, then adding an aqueous macroemulsion of at least one ethylenically unsaturated monomer C with at least two double bonds in the molecule and completing the polymerization following extensive accumulation of the effect substances on the surface of the resulting polymer particles. If a crosslinker is used, then it can also be incorporated into the miniemulsion together with the monomers (a) and (b), or be emulsified in water and the aqueous emulsion of the crosslinker be used in the polymerization as initial charge or metered in batchwise or continuously as emulsion feed. If at least two crosslinkers are used, these can either be metered in as a mixture or separately from one another synchronologically or at intervals.

As a rule, up to at most 40% by weight of the miniemulsion is initially introduced into a polymerization zone, the initially introduced fraction of the miniemulsion is then heated to the polymerization temperature, and an amount of polymerization initiator which suffices to polymerize at most 50% of the initially introduced monomers is added, then an aqueous macroemulsion of at least one ethylenically unsaturated monomer C with at least two double bonds in the molecule is added and, following extensive accumulation of the effect substances on the surface of the resulting polymer particles, the polymerization is completed through the further addition of at least one polymerization initiator.

Preferably, the miniemulsion comprising at least one effect substance is initially introduced in an amount of at most 30% by weight together with an amount of polymerization initiator which suffices to polymerize 5 to 25% of the initially introduced monomers. Particular preference is given to an embodiment in which the miniemulsion comprising at least one effect substance is initially introduced in an amount of at most 25% by weight together with an amount of polymerization initiator which suffices to polymerize at most 15% of the initially introduced monomers.

In another embodiment of the invention, the remaining fractions of this miniemulsion and an aqueous mixture of a monomer (c) are added to a mixture, heated to the polymerization temperature, of an initially introduced miniemulsion comprising at least one effect substance of the monomers (a) and (b) and polymerization initiator which suffices to initiate at most 25% of the initially introduced monomers and, following consumption of the added initiator as a result of polymerization, further polymerization initiator is added to polymerize the remaining monomers.

Preferably, the monomers of group

(a) used are methyl methacrylate, styrene, vinyl acetate, methyl acrylate, acrylic acid and/or methacrylic acid,

(b) used are lauryl acrylate, palmityl acrylate and/or stearyl acrylate and

(c) used are butanediol diacrylate, divinylbenzene, pentaerythritol triacrylate and/or pentaerythritol tetraacrylate.

This gives aqueous polymer dispersions comprising effect substances in which the effect substances are arranged at the surface of the dispersed polymer particles. The solids concentration of these aqueous dispersions is, for example, 10 to 60% by weight, preferably 20 to 45% by weight. From such aqueous dispersions it is possible to obtain polymer powders comprising effect substances by evaporating the volatile constituents of a polymer dispersion comprising aqueous effect substances. In order to obtain pulverulent products, the aqueous dispersions comprising effect substances are preferably subjected to spray-drying. The dispersions according to the invention and the polymer powders obtained therefrom have the advantage that they comprise the effect substances at their surface. The effect substances are thus in a modification which is particularly advantageous for their use. This fact relates in particular to those polymer powders which comprise a UV absorber, preferably 4-n-octyloxy-2-hydroxy-benzophenone, at their surface.

The above-described aqueous polymer dispersions which comprise effect substances at the surface of dispersed polymer particles are used, for example, for stabilizing polymers against the effect of UV radiation, oxygen and heat, in cosmetic and pharmaceutical formulations, in surface coating layers, during the production of paper, leather and textiles and in formulations for animal nutrition. Depending on the application, customary additives, such as antifoams, thickeners, biocides, buffers, anti-freeze agents, fats and/or oils, can be added to the dispersions according to the invention. The use of the dispersions according to the invention is essentially determined by the effect substances present in the dispersions. For example, aqueous dispersions comprising UV absorbers, or the powders obtained therefrom are used in cosmetic formulations or for stabilizing polymers, in particular films made of polymers such as polyethylene, polypropylene, polyvinyl chloride, polycarbonate, polyamide or polyester, to counter the effect of UV radiation. The stabilization of films to counter the effect of UV radiation is particularly important for those films which are used for greenhouses. Apart from the application in the film sector, the products according to the invention which comprise a UV absorber can also be used for stabilizing moldings of any shape made of at least one of the abovementioned polymers, in particular polyethylene, polypropylene, acrylonitrile-butadiene-styrene polymers (ABS) and PVC. A specific example is the use of the products according to the invention for stabilizing profiles made of PVC for window frames. Aqueous dispersions comprising UV absorbers, or the polymer powders obtained therefrom, can also be used together with other dispersions according to the invention which comprise, for example, stabilizers for polymers such as antioxidants for stabilizing polymers and surface coating layers.

Aqueous polymer dispersions comprising alkenylsuccinic anhydrides which are obtainable according to the invention are added as bulk sizing agent to the pulp during papermaking. According to the method of the invention, it is also possible to deposit C₁₄- to C₂₂-alkylketene dimers and the other above-described effect substances on the surface of polymer particles with an average diameter of <500 nm, likewise resulting in aqueous polymer dispersions comprising alkyldiketenes which are used as bulk sizing agents or surface sizing agents for paper. They are added to the pulp during paper-making or are applied in a film press or size press or a gate-roll.

### EXAMPLES

The percentages given in the examples are percentages by weight. The droplet size of the miniemulsion and the average particle size of the aqueous polymer dispersions prepared by miniemulsion polymerization were determined using a Coulter N4 Plus Particle Analyzer on 0.01% strength by weight samples of the emulsion.

The average particle size of the dispersed polymer particles was determined using a Coulter LS230 on 0.01% strength by weight samples of the aqueous dispersions.

### Example 1

Preparation of the UV Absorber Monomer Solution

46.8 g of the pulverulent UV absorber 4-n-octyloxy-2-hydroxybenzophenone were dissolved in a mixture of 156.7 g of methyl methacrylate, 11.7 g of stearyl acrylate, 7 g of acrylic acid and 11.7 g of butanediol diacrylate at room temperature over the course of 15 minutes.

Preparation of the Miniemulsion

This solution was then introduced, with stirring, into an aqueous solution of 3.5 g of an aqueous Steinapol NLS solution (15% strength) in 435.8 g of water. This gave a macroemulsion, which was then converted to a droplet size of about 200 nm by passing it three times through an APV-Gaulin high-pressure homogenizer. The miniemulsion prepared in this way was storage-stable.

Miniemulsion Polymerization

161.5 g (24% of the total amount) of the above-described miniemulsion were initially introduced into a reactor and heated to 80° C. At 80° C., 0.7 g of a 1% strength aqueous solution of Dissolvine E-Fe13 (ironII salt solution) and 9.35 g of a 2% strength aqueous sodium persulfate solution were added in one portion. 511.6 g (76% of the total amount) of the miniemulsion and at the same time, in a separate feed, 112.2 g of a 2% strength aqueous sodium persulfate solution were then metered in, in each case over the course of 60 minutes.

Emulsion Polymerization

After the miniemulsion polymerization, an emulsion polymerization was carried out by metering a macroemulsion which was stirred and composed of 58.5 g of methyl methacrylate, 2.3 g of pentaerythritol tetraacrylate and 1.2 g of 15% strength aqueous sodium lauryl sulfate solution in 30.4 g of completely demineralized water into the dispersion obtained by miniemulsion polymerization over the course of 60 minutes. For the after-polymerization, 112.2 g of a 2% strength aqueous sodium persulfate solution were then added over the course of 60 minutes, the reaction mixture was then stirred for a further 60 minutes at 80° C., then cooled to 25° C. and filtered over a 500 μm and a 125 μm mesh sieve in order to remove the coagulate (7 g). This gave an aqueous polymer dispersion with an average particle diameter of the polymer particles of 62 nm. As electron micrographs on pulverulent polymer particles which have been obtained by drying the aqueous dispersion have shown, the UV absorber surrounded the polymer particles in the form of a shell.

### Example 2

Preparation of the UV Absorber Monomer Solution

46.8 g of the pulverulent UV absorber 4-n-octyloxy-2-hydroxybenzophenone were dissolved in a mixture of 156.7 g of methyl methacrylate, 11.7 g of stearyl acrylate, 7 g of acrylic acid and 11.7 g of butanediol 1,4-diacrylate at room temperature over the course of 15 minutes.

Preparation of the Miniemulsion

This solution was then introduced, with stirring, into an aqueous solution of 3.5 g of a 15% strength aqueous sodium lauryl sulfate solution in 435.8 g of water. This gave a macroemulsion, which was then converted to a droplet size of 200 nm by passing it three times through an APV-Gaulin high-pressure homogenizer. The miniemulsion obtained in this way was storage-stable.

Miniemulsion Polymerization

161.5 g (24% of the total amount) of the miniemulsion were initially introduced into a reactor and heated to 80° C. At 80° C., 0.7 g of a 1% strength aqueous solution of Dissolvine E-Fe13 (ironII salt solution) and 9.35 g of a 2% strength aqueous solution of sodium persulfate were added in one portion. The fraction of the miniemulsion of 511.6 g (76% of the total amount) still remaining and, starting at the same time in a separate feed, 112.2 g of a 2% strength aqueous sodium persulfate solution were then metered in, in each case over the course of 60 minutes.

Emulsion Polymerization

Directly after the addition of the miniemulsion and of the starter solution was complete, a stirred macroemulsion consisting of 58.5 g of methyl methacrylate, 2.3 g of divinylbenzene and 1.2 g of 15% strength aqueous sodium lauryl sulfate solution in 30.4 g of completely demineralized water was metered into the aqueous dispersion heated to 80° C. over the course of 60 minutes.

After-Polymerization

112.2 g of a 2% strength aqueous sodium persulfate solution were then added to the above-described reaction mixture over the course of 60 minutes. The reaction mixture was then stirred for a further 60 minutes at 80° C., then left to cool to 25° C. and filtered through a 500 μm and a 125 μm mesh sieve in order to remove the coagulate (7 g). This gave an aqueous polymer dispersion with an average particle diameter of the polymer particles of 64 nm. As electron micrographs on pulverulent polymer particles which had been obtained by drying the aqueous dispersion have shown, the UV absorber surrounded the polymer particles.

### Example 3

Preparation of the UV Absorber Monomer Solution

47.5 g of the pulverulent UV absorber 4-n-octyloxy-2-hydroxybenzophenone were dissolved in a mixture of 225.7 g of methyl methacrylate and 11.9 g of stearyl acrylate at room temperature over the course of 15 minutes.

Preparation of the Miniemulsion

This solution was then introduced into an aqueous solution of 4.8 g of a 15% strength aqueous sodium lauryl sulfate solution in 626.4 g of water and emulsified. The macroemulsion prepared in this way was then converted to a droplet size of about 200 nm by passing it three times through an APV-Gaulin high-pressure homogenizer. The miniemulsion was storage-stable.

Crosslinking and Prepolymerization

219.8 g (24% of the total amount) of the miniemulsion were initially introduced into a reactor and heated to 80° C. At 80° C., 0.7 g of a 1% strength aqueous solution of Dissolvine E-Fe13 (ironII sulfate solution) and 2.9 g of a 5% strength aqueous solution of sodium persulfate were then added in one portion. 696.3 g (76% of the total amount) of the miniemulsion and, at the same time in a separate feed, a stirred mixture (emulsion) of 23.8 g of water and 11.9 g of pentaerythritol tetraacrylate were then metered in, in each case over the course of 60 minutes. The reaction mixture was then stirred for a further 30 minutes at 80° C. After this time, only about 10% of the monomers were polymerized.

Polymerization

In order to polymerize the monomers extensively, 44.6 g of a 5% strength aqueous solution of sodium persulfate were metered into the reaction mixture heated to 80° C. over a period of 60 minutes, the mixture was then stirred for a further 60 minutes at 80° C. for the after-polymerization, then left to cool to 25° C. and filtered through a 500 μm and a 125 μm mesh sieve in order to remove the coagulate.

This gave an aqueous polymer dispersion with an average particle diameter of the polymer particles of 61 nm. As an electron micrograph on pulverulent polymer particles which has been obtained by drying the aqueous dispersion has shown, the UV absorber surrounds the polymer particle. This can be seen clearly in FIG. 1.

### Example 4

Preparation of the UV Absorber Monomer Solution

46 g of Uvinul 3008 (4-n-octyloxy-2-hydroxybenzophenone) were dissolved in a mixture of 218.5 g of methyl methacrylate and 11.5 g of decahydronaphthalene at room temperature over the course of 15 minutes.

Preparation of the Miniemulsion

This solution was then introduced into 4.6 g of a 15% strength aqueous sodium lauryl sulfate solution in 537.62 g of demineralized water and emulsified. The macroemulsion produced in this way was then converted to a droplet size of 200 nm by sonication with an ultrasound finger from Hilscher. This miniemulsion was storage-stable.

Miniemulsion Polymerization and Emulsion Polymerization

196.4 g (24% of the total amount) of the miniemulsion were initially introduced into a reactor and heated to 80° C. At 80° C., 6.9 g of a 2% strength aqueous solution of sodium persulfate were added in one portion. Then, 621.9 g (76% of the total amount) of the miniemulsion and, at the same time, in a separate feed, a stirred mixture (emulsion) of 23 g of water, 11.5 g of pentaerythritol tetraacrylate and 1.15 g of a 15% strength aqueous sodium lauryl sulfate solution were metered in over the course of 60 minutes in each case. The reaction mixture was then stirred for a further 30 minutes at 80° C. After this time, only about 10% of the monomers had polymerized.

In order to complete the polymerization, 108.1 g of a 2% strength aqueous solution of sodium persulfate were metered into the reaction mixture heated to 80° C. over a period of 60 minutes, the mixture was then stirred for a further 60 minutes at 80° C. for afterpolymerization, then left to cool to 25° C. and filtered over a 500 μm and a 125 μm mesh sieve in order to remove the coagulate.

This gave an aqueous polymer dispersion with an average particle diameter of the polymer particles of 492 nm. As electron micrographs on pulverulent polymer particles which have been obtained by drying the aqueous dispersion show, predominantly very large to 1 μm-sized sometimes very irregularly shaped particles agglomerated during the drying operation are found which carry the UV absorber in the shell and are virtually empty in the core.

### Example 5

The aqueous polymer dispersion which was prepared according to Example 3 was dried to give a powder. Then, at a temperature of 200° C., 96.88 parts of polyethylene (Lupolen® 1840 D) were compounded in a twin-screw extruder with 3.12 parts of the powder obtained from the dispersion, and then the granules were processed to give a film with a thickness of 100 μm. The zero UV-vis spectrum between 200 and 800 nm was firstly measured on this film. The film was then weathered in accordance with ISO 4892-2. After the times given in each case in the table, the transmission at λmax 265 nm was measured. The results are given in the table. If, instead of the powder, the aqueous dispersion is kneaded in with evaporation of the water, similarly good results are obtained.

### Comparative Example 1

Example 4 was repeated except that instead of the powder which was obtained from the aqueous dispersion prepared according to Example 3, now 0.5% of the UV absorbers 4-n-octyloxy-2-hydroxybenzophenone in polyethylene were incorporated, a film was produced therefrom, which was likewise weathered in accordance with ISO 4892-2 and analyzed with regard to transmission after the times given in the table.

| | | | | | | TABLE |
|---|---|---|---|---|---|---|
| | | | | | | Absorption |
| | Transmission at λmax 265 nm [%] after | | | | | loss at |
| | | 1000 | 2000 | 3000 | 4000 | 265 nm [%] |
| Sample as in | 0 | h | h | h | h | after 2000 h |
| Example 5 | 32 | 34 | 34 | 38 | 47 | −1.5 |
| Comparative | 32 | 43 | 75 | 68 | Film was | −63 |
| example 1 | | | | | destroyed | |

1. An aqueous polymer dispersion comprising effect substances and having an average particle diameter of the dispersed particles of <500 nm, where the polymer particles comprise a polymer matrix constructed from at least one ethylenically unsaturated monomer as core, and the effect substances which are soluble in the monomers which form the polymer matrix of the particles are essentially arranged on the surface of the polymer particles.

2. The aqueous polymer dispersion comprising effect substances according to claim 1, wherein the effect substances are arranged as a shell around the core of the polymer particles.

3. The aqueous polymer dispersion comprising effect substances according to claim 1, wherein the amount of the effect substances is 0.5 to 50% by weight, based on the polymer matrix.

4. The aqueous polymer dispersion comprising effect substances according to claim 1, wherein the effect substances are chosen from the group of UV absorbers, organic dyes, optical brighteners, stabilizers and auxiliaries for organic polymers, IR dyes, flame retardants, alkenylsuccinic anhydrides, pharmaceutical active ingredients and biocides.

5. The aqueous polymer dispersion comprising effect substances according to claim 1, wherein the core of the dispersed particles is essentially constructed from a polymer of
(a) at least one ethylenically unsaturated monomer A with a solubility in water of >0.01 g/l (at 25° C. and 1 bar),
(b) at least one ethylenically unsaturated monomer B with a solubility in water of <0.01 g/l (at 25° C. and 1 bar) and,
(c) at least one ethylenically unsaturated monomer with at least two double bonds.

6. The aqueous polymer dispersion comprising effect substances as claimed in one of claim 1, wherein the dispersed polymer particles comprise
(a) 50 to 99.5% by weight of at least one monomer A,
(b) 0.5 to 50% by weight of at least one monomer B and
(c) 0 to 30% by weight of at least one monomer C
in copolymerized form.

7. The aqueous polymer dispersion comprising effect substances according to claim 1, wherein the dispersed polymer particles are constructed from a polymer of
(a) methyl methacrylate, styrene, vinyl acetate, methyl acrylate, ethyl methacrylate, acrylic acid, methacrylic acid, and mixtures thereof,
(b) lauryl acrylate, palmityl acrylate, stearyl acrylate and mixtures thereof and,
(c) butanediol diacrylate, divinylbenzene, pentaerythritol triacrylate, and pentaerythritol tetraacrylate.

8. The aqueous polymer dispersion comprising effect substances according to claim 1, wherein the dispersed polymer particles are constructed from a polymer of
(a) methyl methacrylate, ethyl methacrylate, acrylic acid, and mixtures thereof,
(b) stearyl acrylate, palmityl acrylate and mixtures thereof and
(c) butanediol diacrylate, pentaerythritol tetraacrylate, pentaerythritol triacrylate and mixtures thereof.

9. The aqueous polymer dispersion comprising UV absorbers as effect substances according to claim 1, wherein the dispersed polymer particles are constructed from a polymer of
(a) methyl methacrylate or methyl methacrylate and acrylic acid,
(b) stearyl acrylate and
(c) butanediol diacrylate, pentaerythritol tetraacrylate, pentaerythritol triacrylate and mixtures thereof
and are coated with a shell of the UV absorber 4-n-octyloxy-2-hydroxybenzophenone.

10. A method of producing aqueous polymer dispersions comprising effect substances and having an average particle diameter of the dispersed polymer particles of <500 nm by miniemulsion polymerization of ethylenically unsaturated monomers, wherein a miniemulsion with an average particle size of the emulsified droplets of <500 nm is prepared by emulsifying ethylenically unsaturated monomers in water in the presence of at least one effect substance and a surface-active agent, and it is polymerized in such a way in the presence of at least one free-radical polymerization initiator that initially only at most 50% of the monomers which are situated in the polymerization zone polymerize and where the effect substances migrate to the surface of the emulsified particles, and the polymerization is complete only after extensive or complete accumulation of the effect substances on the surface of the resulting polymer particles.

11. The method according to claim 10, wherein a miniemulsion of the monomers
(a) at least one ethylenically unsaturated monomer A with a solubility in water of >0.01 g/l (at 25° C. and 1 bar),
(b) at least one ethylenically unsaturated monomer B with a solubility in water of <0.01 g/l (at 25° C. and 1 bar) and,
(c) at least one ethylenically unsaturated monomer C with at least two double bonds
which comprise at least one effect substance, at least one emulsifier and at least one hydrophobic organic compound with a solubility in water of <0.1 g/l (at 25° C. and 1 bar) is firstly prepared, the monomers of the miniemulsion are then polymerized to a conversion of at most 50%, then an aqueous macroemulsion of at least one ethylenically unsaturated monomer C with at least two double bonds in the molecule is added and the polymerization is completed following extensive accumulation of the effect substances on the surface of the resulting polymer particles.

12. The method according to claim 10, wherein up to at most 40% by weight of the miniemulsion is initially introduced into a polymerization zone, the initially introduced fraction of the miniemulsion is then heated to the polymerization temperature and an amount of polymerization initiator which suffices to polymerize at most 50% of the initially introduced monomers is added, then an aqueous macroemulsion of at most one ethylenically unsaturated monomer C with at least two double bonds in the molecule is added and, following extensive accumulation of the effect substances on the surface of the resulting polymer particles, the polymerization is completed by further adding at least one polymerization initiator.

13. The method according to claim 12, wherein the miniemulsion is initially introduced in an amount of at most 30% by weight together with an amount of polymerization initiator which suffices to polymerize 5 to 25% of the initially introduced monomers.

14. The method according to claim 12, wherein the miniemulsion is initially introduced in an amount of at most 25% by weight together with an amount of polymerization initiator which suffices to polymerize at most 15% of the initially introduced monomers.

15. The method according to claim 12, wherein the remaining fractions of the miniemulsion and an aqueous mixture of a polymer (c) are added to a mixture, heated to the polymerization temperature, of an initially introduced miniemulsion of the monomers (a) and, (b) comprising an effect substance and polymerization initiator which suffices to initiate at most 25% of the initially introduced monomers and, following consumption of the added initiator as a result of polymerization, further polymerization initiator is added to polymerize the remaining monomers.

16. The method according to claim 12, wherein the remaining fractions of the miniemulsion and an aqueous macroemulsion of a monomer (c) are added to a mixture, heated to the polymerization temperature, of an initially introduced miniemulsion of the monomers (a) and, (b) comprising at least one effect substance and polymerization initiator which suffices to initiate at most 15% of the initially introduced monomers and, following consumption of the added initiator as a result of polymerization, further polymerization initiator is added to polymerize the remaining monomers.

17. The method according to claim 10, wherein the monomers are selected from the group consisting essentially of
(a) used are methyl methacrylate, styrene, vinyl acetate, methyl acrylate, acrylic acid, methacrylic acid, and mixtures thereof,
lauryl acrylate, palmityl acrylate, stearyl acrylate and mixtures thereof and
(c) butanediol diacrylate, divinylbenzene, pentaerythritol triacrylate, pentaerythritol tetraacrylate and mixtures thereof.

18. A polymer powder comprising effect substances and prepared by evaporating the volatile constituents of an aqueous polymer dispersion comprising effect substances according to claim 1.

19. The polymer powder comprising effect substances according to claim 18, wherein the effect substance present is a UV absorber.

20. A method of using polymer powder comprising effect substances according to claim 18 for stabilizing polymers against the effect of UV radiation, oxygen and heat, in cosmetic and pharmaceutical formulations, in surface coating layers, during the production of paper, leather or textiles and in formulations for animal nutrition.
